(19) United States
(12) Patent Application Publication
(10) Pub. No.: US 2016/0242001 A1
(43) Pub. Date: Aug. 18, 2016

(54) METHOD AND MOBILE TERMINAL FOR DISPLAYING PROMPT INFORMATION

(71) Applicant: Hisense Mobile Communications Technology Co., Ltd., Qingdao (CN)

(72) Inventors: Tiantian DONG, Qingdao (CN); Wenjuan DU, Qingdao (CN)

(73) Assignee: Hisense Mobile Communications Technology Co., Ltd., Qingdao (CN)

(21) Appl. No.: 14/978,912

(22) Filed: Dec. 22, 2015

(30) Foreign Application Priority Data
Feb. 13, 2015 (CN) 201510080679.4

(51) Int. Cl. H04W 4/02; H04W 52/02; H04W 64/00

(52) U.S. Cl. CPC H04W 4/023; H04W 64/006; H04W 52/0251; H04W 88/02

(57) ABSTRACT

The present disclosure provides a method and a mobile terminal for displaying prompt information. The method of the present disclosure includes: monitoring, by a mobile terminal, an application and/or a process in the mobile terminal; determining, by the mobile terminal, after monitoring data detected for the application and/or the process has reached a set threshold, and according to a correspondence between monitoring data and events, an event that corresponds to the monitoring data; determining, by the mobile terminal, according to a correspondence between events and prompt information, prompt information that corresponds to the event; and playing, by the mobile terminal, video data associated with the determined prompt information on the mobile terminal.

### PRIORITY STATEMENT

This application claims the priority benefit of Chinese Patent Application No. 201510080679.4 filed on Feb. 13, 2015, the disclosure of which is incorporated herein in its entirety by reference.

### BACKGROUND

The present disclosure relates to the technical field of wireless communications, and in particular, to a method and a mobile terminal for displaying prompt information.

### RELATED ART

At present, a built-in sensor of a mobile terminal may feedback, when detecting corresponding information, corresponding prompt information to the mobile terminal. For example, a built-in light sensor of a mobile terminal may detect ambient light brightness, and then feedback corresponding prompt information on the ambient light brightness to the mobile terminal; a built-in temperature sensor of a mobile terminal may detect a temperature, and then feedback corresponding prompt information on the temperature to the mobile terminal; a built-in gravity sensor of a mobile terminal may detect a gravitational acceleration of the mobile terminal, and then feedback corresponding prompt information on the gravitational acceleration to the mobile terminal; a built-in distance sensor of a mobile terminal may detect a distance between the mobile terminal and a target terminal, and then feedback corresponding prompt information on the distance to the mobile terminal; and a built-in pressure sensor of a mobile terminal may detect a pressure load of the mobile terminal, and then feedback corresponding prompt information on the pressure load to the mobile terminal. The mobile terminal presents the aforementioned prompt information to a user, so as to prompt the user to adopt a corresponding operation according to the prompt information.

In addition, during running of an application and a process in a mobile terminal, when any abnormality occurs, or it is necessary to prompt a user, prompt information may also be fed back to the mobile terminal. The mobile terminal presents the aforementioned prompt information to the user, so as to prompt the user to adopt a corresponding operation according to the prompt information.

Conventionally, different built-in sensors of a mobile terminal present prompt information to a user through the mobile terminal with different manners and effects. Similarly, different applications and different processes run on a mobile terminal also present prompt information to a user through the mobile terminal with different manners and effects.

In conclusion, built-in sensors of an existing mobile terminal, applications and processes run on an existing mobile terminal present prompt information to a user through the mobile terminal with different manners and effects, which produces a poor prompting effect.

### SUMMARY

The present disclosure provides a method and a mobile terminal for displaying prompt information, so as to solve a problem that built-in sensors of a mobile terminal, applications and processes run on a mobile terminal present prompt information by using the mobile terminal to a user with different manners and effects, which produces a poor prompting effect.

An embodiment of the present disclosure provides a method for displaying prompt information, including:
monitoring, by a mobile terminal, an application and/or a process in the mobile terminal after startup;
determining, by the mobile terminal, after monitoring data detected for the application and/or the process has reached a set threshold, and according to a correspondence between monitoring data and events, an event that corresponds to the monitoring data;
determining, by the mobile terminal, according to a correspondence between events and prompt information, prompt information that corresponds to the event; and
playing, by the mobile terminal, video data associated with the determined prompt information on the mobile terminal.

In this embodiment of the present disclosure, as a mobile terminal monitors an application and/or a process in the mobile terminal after startup, and plays video data associated with prompt information on the mobile terminal with a unified manner and effect, a good prompting effect is produced.

For example, the application is a system application of the mobile terminal, and/or the application is a non-system application of the mobile terminal; and
the process is a system process of the mobile terminal, and/or the process is a sensor process of a built-in sensor of the mobile terminal.

In this embodiment of the present disclosure, as a mobile terminal can monitor a system application, a non-system application, a system process and a sensor process of the mobile terminal after startup, so that prompt information is more comprehensive, thereby producing a better prompting effect.

For example, the monitoring data detected by the mobile terminal for the application and/or the process has reached a set threshold, includes:
monitoring data detected by the mobile terminal for the application and/or the process within a specific time period that separately corresponds to the application and/or the process, has reached a set threshold, where different applications and different processes respectively correspond to different specific time periods.

For example, the event includes some or all of the following events: an event of low available memory space of a mobile terminal, an event of system updating of a mobile terminal, an event of high power consumption by a single process of a mobile terminal, an event of high memory consumption by a single process of a mobile terminal, an event of an excessively great difference between screen brightness of a mobile terminal and ambient light, an event of an excessively high ambient temperature detected by a mobile terminal, an event of an excessively low ambient temperature detected by a mobile terminal, an event of falling of a mobile terminal, an event of rapid movement of a mobile terminal, an event of a small distance between a mobile terminal and a target terminal, and an event of high load pressure of a mobile terminal.

For example, the prompt information is a segment of virtual image motion animation of a virtual image in the mobile terminal.

In this embodiment of the present disclosure, as a mobile terminal displays a virtual image motion of a virtual image on the mobile terminal, a good prompting effect is produced.

For example, after the playing, by the mobile terminal, video data associated with the determined prompt information on the mobile terminal, the method further includes:
closing the prompt information after a close instruction sent by a user for closing the prompt information is received by the mobile terminal; or
closing the prompt information after the duration of the prompt information displaying on the mobile terminal has reached a set time length.

An embodiment of the present disclosure provides a mobile terminal for displaying prompt information, including:
a monitoring module, configured to monitor an application and/or a process in the mobile terminal after startup;
a first determining module, configured to determine, after monitoring data detected for the application and/or the process has reached a set threshold, and according to a correspondence between monitoring data and events, an event that corresponds to the monitoring data;
a second determining module, configured to determine, according to a correspondence between events and prompt information, prompt information that corresponds to the event; and
a display module, configured to play video data associated with the determined prompt information on the mobile terminal.

For example, the application is a system application of the mobile terminal, and/or the application is a non-system application of the mobile terminal; and
the process is a system process of the mobile terminal, and/or the process is a sensor process of a built-in sensor of the mobile terminal.

For example, the first determining module is specifically configured to:
determine, after monitoring data detected for the application and/or the process within a specific time period that separately corresponds to the application and/or the process has reached a set threshold, an event that corresponds to the monitoring data, where different applications and different processes respectively correspond to different specific time periods.

For example, the event includes some or all of the following events: an event of low available memory space of a mobile terminal, an event of system updating of a mobile terminal, an event of high power consumption by a single process of a mobile terminal, an event of high memory consumption by a single process of a mobile terminal, an event of an excessively great difference between screen brightness of a mobile terminal and ambient light, an event of an excessively high ambient temperature detected by a mobile terminal, an event of an excessively low ambient temperature detected by a mobile terminal, an event of falling of a mobile terminal, rapid movement of a mobile terminal, an event of a small distance between a mobile terminal and a target terminal, and an event of high load pressure of a mobile terminal.

For example, the prompt information is a segment of virtual image motion animation of a virtual image in the mobile terminal.

For example, the display module is further configured to:
close the prompt information after a close instruction sent by a user for closing the prompt information is received; or
close the prompt information after the duration of the prompt information displaying on the mobile terminal has reached a set time length.

In this embodiment of the present disclosure, as a mobile terminal monitors an application and/or a process in the mobile terminal after startup, and displays prompt information on the mobile terminal with a unified manner and effect, a good prompting effect is produced.

### BRIEF DESCRIPTION OF THE DRAWINGS

FIG. 1 is a schematic flowchart of a method for displaying prompt information according to Embodiment 1 of the present disclosure;

FIG. 2 is a schematic structural diagram of a mobile terminal for displaying prompt information according to Embodiment 2 of the present disclosure; and

FIG. 3 is a schematic diagram illustrating an example embodiment of an electronic device.

### DETAILED DESCRIPTION

In the embodiments of the present disclosure, a mobile terminal monitors an application and/or a process in the mobile terminal after startup. The mobile terminal determines, after monitoring data detected for the application and/or the process has reached a set threshold, and according to a correspondence between monitoring data and events, an event that corresponds to the monitoring data; determines, according to a correspondence between events and prompt information, prompt information that corresponds to the event; and plays video data associated with the determined prompt information on the mobile terminal. In the embodiments of the present disclosure, as a mobile terminal monitors an application and/or a process in the mobile terminal after startup, and displays prompt information on the mobile terminal with a unified manner and effect, a good prompting effect is produced.

The mobile terminal in the embodiments of the present disclosure includes but is not limited to the following mobile terminals: a mobile phone, a computer, a tablet computer, and the like.

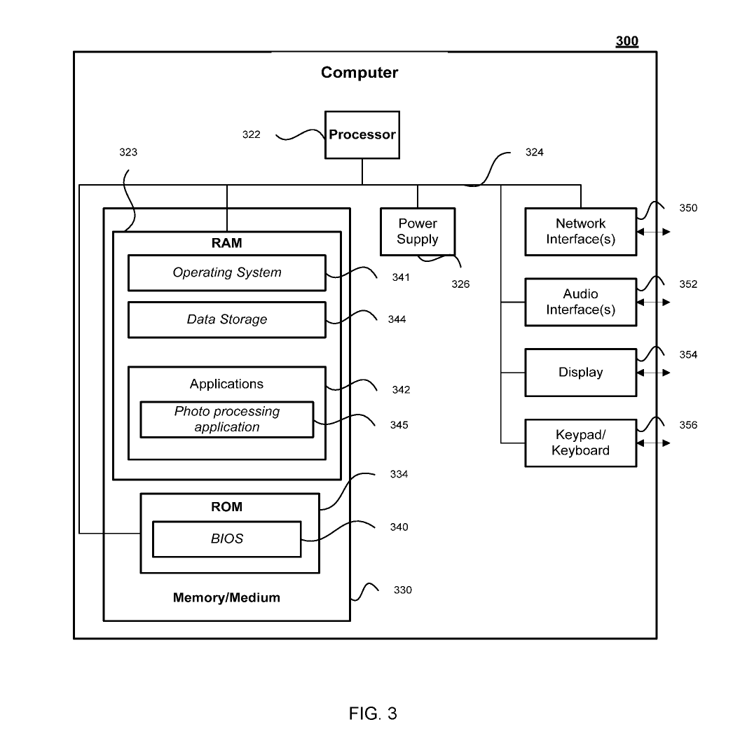

FIG. 3 is a schematic diagram illustrating an example embodiment of an electronic device for implementing methods introduced in the present disclosure. The electronic device 300 may be a computing device capable of executing a software system. The electronic device 300 may, for example, be a device such as a personal desktop computer or a portable device, such as a laptop computer, a tablet computer, a cellular telephone, or a smart phone.

The electronic device 300 may vary in terms of capabilities or features. Claimed subject matter is intended to cover a wide range of potential variations. For example, the electronic device 300 may include am image processing hardware, such as a camera and/or a webcam. It may also include a keypad/keyboard 356 and a display 354, such as a liquid crystal display (LCD), or a display with a high degree of functionality, such as a touch-sensitive color 2D or 3D display. In contrast, however, as another example, a web-enabled electronic device 300 may include one or more physical or virtual keyboards, and mass storage medium 330.

The electronic device 300 may also include or may execute a variety of operating systems 341. The electronic device 300 may include or may execute a variety of possible applications 342, such as a photo processing application 345. An application 342 may enable communication with other devices via a network, such as communicating with another computer or electronic device 300 via a network.

Further, the electronic device 300 may include one or more non-transitory processor-readable storage media 330 and one or more processors 322 in communication with the non-transitory processor-readable storage media 330. For example, the non-transitory processor-readable storage media 330 may be a RAM memory, flash memory, ROM memory, EPROM memory, EEPROM memory, registers, hard disk, a removable disk, a CD-ROM, or any other form of non-transitory storage medium known in the art. The one or more non-transitory processor-readable storage media 330 may store sets of instructions, or units and/or modules that include the sets of instructions, for conducting operations and/or method steps described in the present disclosure. Alternatively, the units and/or modules may be hardware disposed in the electronic device 300 configured to conduct operations and/or method steps described in the present disclosure. The one or more processors may be configured to execute the sets of instructions and perform the methods and/or operations in example embodiments of the present disclosure.

Merely for illustration, only one processor will be described in electronic devices that execute operations and/or method steps in the following example embodiments. However, it should be note that the electronic devices in the present disclosure may also include multiple processors, thus operations and/or method steps that are performed by one processor as described in the present disclosure may also be jointly or separately performed by the multiple processors. For example, if in the present disclosure a processor of an electronic device executes both step A and step B, it should be understood that step A and step B may also be performed by two different processors jointly or separately in the electronic device (e.g., the first processor executes step A and the second processor executes step B, or the first and second processors jointly execute steps A and B).

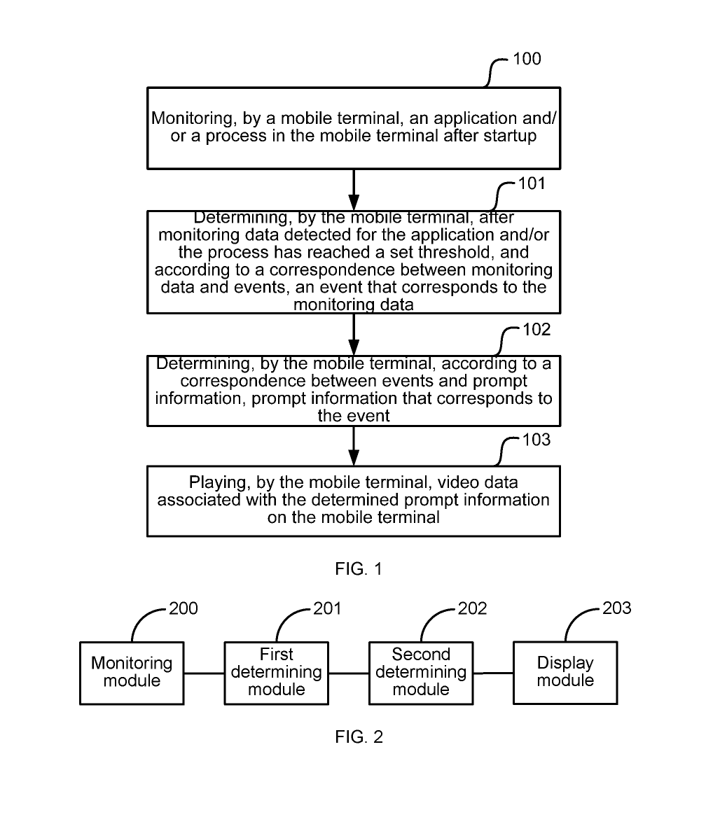

FIG. 1 is a schematic flowchart of a method for displaying prompt information. The method may be implemented as a set of instructions and stored in the storage medium 330 of the electronic device 300, which may be a mobile terminal. The processor 322 may execute the set of instructions to perform operations of the method. The operations may include:

Step 100: Monitoring, by the mobile terminal, an application and/or a process in the mobile terminal after startup and receiving, by the mobile terminal, corresponding monitoring data.

Step 101: Determining, by the mobile terminal, an event that corresponds to the monitoring data after the monitoring data being detected and/or received for the application and/or the process has reached a set threshold, and according to a correspondence between monitoring data and events,.

Step 102: Determining, by the mobile terminal, according to a correspondence between events and prompt information, prompt information that corresponds to the event.

Step 103: Playing, by the mobile terminal, video data associated with the determined prompt information on the mobile terminal.

In this embodiment of the present disclosure, a mobile terminal can monitor different applications and different processes.

For example, the application is a system application of the mobile terminal, and/or the application is a non-system application of the mobile terminal; and

The process is a system process of the mobile terminal, and/or the process is a sensor process of a built-in sensor of the mobile terminal.

In this embodiment of the present disclosure, the sensor includes but is not limited to the following sensors: a light sensor, a temperature sensor, a gravity sensor, a pressure sensor, a GPS module, a gyroscope, and the like.

For example, when a mobile terminal needs to feedback information on ambient light brightness to a user, the information on ambient light brightness is acquired by means of monitoring a light sensor; when a mobile terminal needs to feedback ambient temperature information to a user, the ambient temperature information is acquired by means of monitoring a temperature sensor; when a mobile terminal needs to feedback gravitational acceleration information to a user, the gravitational acceleration information is acquired by means of monitoring a gravity sensor; when a mobile terminal needs to feedback pressure load information to a user, the pressure load information is acquired by means of monitoring a pressure sensor; when a mobile terminal needs to feedback current position information to a user, the current position information is acquired by means of monitoring a GPS module; and when a mobile terminal needs to feedback screen rotation information to a user, the screen rotation information is acquired by means of monitoring a gyroscope.

In this embodiment of the present disclosure, the mobile terminal may determine detected monitoring data has reached a set threshold according to different approaches:

### Approach 1:

Monitoring data detected by the mobile terminal for the application and/or the process at a certain time has reached a set threshold.

### Approach 2:

For example, the monitoring data detected by the mobile terminal for the application and/or the process has reached a set threshold, includes:

Monitoring data detected by the mobile terminal for the application and/or the process within a specific time period that separately corresponds to the application and/or the process, has reached a set threshold, where different applications and different processes respectively correspond to different specific time periods.

In this embodiment of the present disclosure, the event includes some or all of the following events: an event of low power of a mobile terminal, an event of low available memory space of a mobile terminal, an event of system updating of a mobile terminal, an event of high power consumption by a single process of a mobile terminal, an event of high memory consumption by a single process of a mobile terminal, an event of an excessively great difference between screen brightness of a mobile terminal and ambient light, an event of an excessively high ambient temperature detected by a mobile terminal, an event of an excessively low ambient temperature detected by a mobile terminal, an event of falling of a mobile terminal, an event of rapid movement of a mobile terminal, an event of a small distance between a mobile terminal and a target terminal, and an event of high load pressure of a mobile terminal.

In this embodiment of the present disclosure, a virtual image may be preset in a mobile terminal, or a virtual image may be selected by a user from a plurality of virtual images that are preset in a mobile terminal, so as to display prompt information by using a virtual image. The specific implementation manner is as follows:

For example, the prompt information is a segment of virtual image motion animation of a virtual image in the mobile terminal.

The virtual image motion in this embodiment of the present disclosure includes at least one of the following motions: speaking, expression, and action.

In this embodiment of the present disclosure, after a mobile terminal displays determined prompt information on the mobile terminal, the prompt information may be closed in different manners. The specific implementation manner is as follows:
The prompt information is closed after a close instruction sent by a user for closing the prompt information is received by the mobile terminal; or
The prompt information is closed after the duration of the prompt information displaying on the mobile terminal has reached a set time length.

For example: after startup, a mobile terminal starts to monitor all system applications, all non-system applications, all system processes and all sensor processes in the mobile terminal. During a process of monitoring, if monitoring data of a battery process obtained at a certain time is a remaining battery capacity of 4%, and a set threshold corresponding to the battery process is a remaining battery capacity of less than 5%, the monitoring data has reached the set threshold. According to a correspondence between monitoring data and events, an event that corresponds to the monitoring data is determined as an event of low power of a mobile terminal; and according to a correspondence between events and prompt information, prompt information that corresponds to the event of low power of a mobile terminal is determined; and the mobile terminal displays the determined prompt information thereon, until a close command from a user for closing the prompt information is received.

For another example: after startup, a mobile terminal starts to monitor all system applications, all non-system applications, all system processes and all sensor processes in the mobile terminal. During a process of monitoring, if monitoring data of a memory process obtained at a certain time is a remaining memory size of less than 10%, and a set threshold corresponding to the memory process is a remaining memory size of less than 10%, the monitoring data has reached the set threshold. According to a correspondence between monitoring data and events, an event that corresponds to the monitoring data is determined as an event of low available memory space of a mobile terminal; and according to a correspondence between events and prompt information, prompt information that corresponds to the event of low available memory space of a mobile terminal is determined; and the mobile terminal displays the determined prompt information thereon, until the duration of the prompt information displaying on the mobile terminal has reached a set time length.

For still another example: after startup, a mobile terminal starts to monitor all system applications, all non-system applications, all system processes and all sensor processes in the mobile terminal. During a process of monitoring, if monitoring data of a temperature sensor process obtained at a certain time is an external temperature of 34 degrees, and a set threshold corresponding to the temperature sensor process is an external temperature of more than 30 degrees, the monitoring data has reached the set threshold. According to a correspondence between monitoring data and events, an event that corresponds to the monitoring data is determined as an event of an excessively high ambient temperature detected by a mobile terminal; and according to a correspondence between events and prompt information, a virtual image motion that corresponds to the event of an excessively high ambient temperature detected by a mobile terminal is determined; and the mobile terminal displays an expression of sweat streaming of a virtual image thereon, until a close command from a user for closing the prompt information is received.

For still another example: after startup, a mobile terminal starts to monitor all system applications, all non-system applications, all system processes, and all sensor processes. During a process of monitoring, monitoring data for a pressure sensor process obtained at a certain time has reached a set threshold that corresponds to the pressure sensor process; according to a correspondence between monitoring data and events, an event that corresponds to the monitoring data is determined as an event of high load pressure of a mobile terminal; according to a correspondence between events and prompt information, a virtual image motion that corresponds to the event of high load pressure of a mobile terminal is determined; and the mobile terminal displays a virtual image being pressed flat and/or a painful expression of a virtual image thereon, until the duration of the virtual image motion displaying on the mobile terminal has reached a set time length.

For still another example: after startup, a mobile terminal starts to monitor all system applications, all non-system applications, all system processes, and all sensor processes. During a process of monitoring, monitoring data for a gravity sensor process obtained at a certain time has reached a set threshold that corresponds to the gravity sensor process; according to a correspondence between monitoring data and events, an event that corresponds to the monitoring data is determined as an event of falling of a mobile terminal; according to a correspondence between events and prompt information, a virtual image motion that corresponds to the event of falling of a mobile terminal is determined; and the mobile terminal displays an unpleasant expression of a virtual image, until the duration of the virtual image motion displaying on the mobile terminal has reached a set time length.

The above descriptions are merely for the purpose of illustration. A mobile terminal can monitor all applications and processes in the mobile terminal, and when detected monitoring data has reached a corresponding set threshold, corresponding prompt information or a corresponding virtual image motion is displayed on the mobile terminal.

Based on the same inventive conception, an embodiment of the present disclosure further provides a mobile terminal for displaying prompt information. Because a method corresponding to the mobile terminal for displaying prompt information shown in FIG. 2 is the method for displaying prompt information in the exemplary embodiment shown in FIG. 1, for implementation of the mobile terminal in this embodiment of the present disclosure, refer to implementation of a system, and the repetitive content is not described herein again.

FIG. 2 is a schematic structural diagram of a mobile terminal for displaying prompt information. The mobile terminal may be the electronic device 300. Further, the mobile terminal may include the following modules:
a monitoring module 200, configured to monitor an application and/or a process in the mobile terminal after startup;
a first determining module 201, configured to determine, after monitoring data detected for the application and/or the process has reached a set threshold, and according to a correspondence between monitoring data and events, an event that corresponds to the monitoring data;
a second determining module 202, configured to determine, according to a correspondence between events and prompt information, prompt information that corresponds to the event; and
a display module 203, configured to play video data associated with the determined prompt information on the mobile terminal.

For example, the application is a system application of the mobile terminal, and/or the application is a non-system application of the mobile terminal; and
the process is a system process of the mobile terminal, and/or the process is a sensor process of a built-in sensor of the mobile terminal.

For example, the first determining module 201 is specifically configured to:
determine, after monitoring data detected for the application and/or the process within a specific time period that separately corresponds to the application and/or the process has reached a set threshold, an event that corresponds to the monitoring data, where different applications and different processes respectively correspond to different specific time periods.

For example, the event includes some or all of the following events: an event of low power of a mobile terminal, an event of low available memory space of a mobile terminal, an event of system updating of a mobile terminal, an event of high power consumption by a single process of a mobile terminal, an event of high memory consumption by a single process of a mobile terminal, an event of an excessively great difference between screen brightness of a mobile terminal and ambient light, an event of an excessively high ambient temperature detected by a mobile terminal, an event of an excessively low ambient temperature detected by a mobile terminal, an event of falling of a mobile terminal, an event of rapid movement of a mobile terminal, an event of a small distance between a mobile terminal and a target terminal, and an event of high load pressure of a mobile terminal.

For example, the prompt information is a segment of virtual image motion animation of a virtual image in the mobile terminal.

For example, the display module 203 is further configured to:
close the prompt information after a close instruction sent by a user for closing the prompt information is received; or
close the prompt information after the duration of the prompt information displaying on the mobile terminal has reached a set time length.

From the above, in this embodiment of the present disclosure, as a mobile terminal monitors an application and/or a process in the mobile terminal after startup, and displays prompt information on the mobile terminal with a unified manner and effect, a good prompting effect is produced.

A person skilled in the art should understand that, the embodiments of the present disclosure may be provided as a method, a system, or a computer program product. Therefore, the present disclosure may use a form of a hardware embodiment, a software embodiment, or an embodiment combining hardware and software. Moreover, the present disclosure may use a form of computer program product implemented on one or more computer available storage media (including but not limited to a disk memory, a CD-ROM, an optical memory, and the like) including computer available program code.

The present disclosure is described with reference to flowcharts and/or block diagrams according to the method, the device (system), and the computer program product in the embodiments of the present disclosure. It should be understood that, each process and/or block in the flowcharts and/or block diagrams, and a combination of processes and/or blocks in the flowcharts and/or block diagrams may be implemented by computer program instructions. These computer program instructions may be provided to a general-purpose computer, a dedicated computer, an embedded processor, or a processor of another programmable data processing device, to generate a machine, so that an apparatus configured to implement functions specified in one or more processes in the flowcharts and/or one or more blocks in the block diagrams is generated by using instructions executed by the computer or the processor of another programmable data processing device.

These computer program instructions may also be stored in a computer-readable memory that can guide a computer or another programmable data processing device to work in a specific manner, so that the instructions stored in the computer readable memory generate a product including an instruction apparatus, where the instruction apparatus implements functions specified in one or more processes in the flowcharts and/or one or more blocks in the block diagrams.

These computer program instructions may also be loaded into a computer or another programmable data processing device, so that a series of operational steps are performed on the computer or another programmable device to generate processing implemented by a computer, and instructions executed on the computer or another programmable device provide steps for implementing functions specified in one or more processes in the flowcharts and/or one or more blocks in the block diagrams.

Although preferred embodiments of the present disclosure have been described, a person skilled in the art may make other changes and modifications to these embodiments once getting aware of basic creative concepts. Therefore, the appended claims are intended to include the preferred embodiments and all changes and modifications thereof that fall within the scope of the present disclosure.

Apparently, a person skilled in the art may make various changes and transformations to the present disclosure without departing from the spirit and scope of the present disclosure. Thus, if these changes and transformations of the present disclosure fall within the scope of the claims of the present disclosure and the scope of equivalent technologies, the present disclosure is also intended to include these changes and transformations.

1. A mobile terminal, comprising:
a processor-readable storage medium including a set of instructions for displaying prompt information; and
a processor in communication with the storage medium, wherein when executing the set of instructions, the processor is directed to:
obtain monitoring data by monitoring occurrence of a first event in the mobile terminal after startup, wherein the first event comprises running at least an application and a process;
determine occurrence of a second event that corresponds to the monitoring data when the monitoring data reaches a preset threshold value;
determine prompt information that corresponds to the second event; and
play video data associated with the prompt information on the mobile terminal.

2. The mobile terminal according to claim 1, wherein the application is at least a system application of the mobile terminal and an non-system application of the mobile terminal; and
the process is at least a system process of the mobile terminal and a sensor process of a built-in sensor of the mobile terminal.

3. The mobile terminal according to claim 1, wherein the processor is further directed to:
determine that the monitoring data reaches a preset threshold value when the monitoring data correspond to the application and the process have reached the preset threshold value within a preset period of time.

4. The mobile terminal according to claim 1, wherein the second event comprises at least one of:
an event of low available memory space of the mobile terminal,
an event of system updating of the mobile terminal,
an event of high power consumption by a single process of the mobile terminal,
an event of high memory consumption by a single process of the mobile terminal,
an event of an excessively great difference between screen brightness of the mobile terminal and ambient light of the mobile terminal,
an event of an excessively high ambient temperature detected by the mobile terminal,
an event of an excessively low ambient temperature detected by the mobile terminal,
an event of falling of the mobile terminal,
an event of rapid movement of the mobile terminal,
an event of a small distance between the mobile terminal and a target terminal, and
an event of high load pressure of the mobile terminal.

5. The mobile terminal according to claim 1, wherein the prompt information is a segment of virtual image motion animation of a virtual image in the mobile terminal.

6. The mobile terminal according to any one of claim 1, wherein after the playing of the video data associated with the determined prompt information on the mobile terminal, the processor is further directed to:
close the prompt information, after receiving a close instruction for closing the prompt information from a user.

7. The mobile terminal according to any one of claim 1, wherein after the playing of the video data associated with the determined prompt information on the mobile terminal, the processor is further directed to:
close the prompt information, after duration of the prompt information displaying on the mobile terminal has reached a preset time length.

8. A method for displaying prompt information, comprising:
obtaining, by a mobile terminal, monitoring data by monitoring occurrence of a first event in a mobile terminal after startup, wherein the first event comprises running at least an application and a process;
determining, by the mobile terminal, occurrence of a second event that corresponds to the monitoring data when the monitoring data reaches a preset threshold value;
determining, by the mobile terminal, prompt information that corresponds to the second event; and
playing, by the mobile terminal, video data associated with the prompt information on the mobile terminal.

9. The method according to claim 8, wherein the application is at least a system application of the mobile terminal and an non-system application of the mobile terminal; and
the process is at least a system process of the mobile terminal and a sensor process of a built-in sensor of the mobile terminal.

10. The method according to claim 8, further comprising:
determining, by the mobile terminal, that the monitoring data reaches a preset threshold value when the monitoring data correspond to the application and the process have reached the preset threshold value within a preset period of time.

11. The method according to claim 8, wherein the second event comprises at least one of:
an event of low available memory space of the mobile terminal,
an event of system updating of the mobile terminal,
an event of high power consumption by a single process of the mobile terminal,
an event of high memory consumption by a single process of the mobile terminal,
an event of an excessively great difference between screen brightness of the mobile terminal and ambient light of the mobile terminal,
an event of an excessively high ambient temperature detected by the mobile terminal,
an event of an excessively low ambient temperature detected by the mobile terminal,
an event of falling of the mobile terminal,
an event of rapid movement of the mobile terminal,
an event of a small distance between the mobile terminal and a target terminal, and
an event of high load pressure of the mobile terminal.

12. The method according to claim 8, wherein the prompt information is a segment of virtual image motion animation of a virtual image in the mobile terminal.

13. The method according to any one of claim 8, wherein after the playing of the video data associated with the determined prompt information on the mobile terminal, the method further comprises:
closing, by the mobile terminal, the prompt information, after receiving a close instruction for closing the prompt information from a user.

14. The method according to any one of claim 8, wherein after the playing of the video data associated with the determined prompt information on the mobile terminal, the method further comprises:
closing, by the mobile terminal, the prompt information, after duration of the prompt information displaying on the mobile terminal has reached a preset time length.

15. A processor-readable non-transitory storage medium, comprising a set of instructions for displaying prompt information, wherein when executed by a processor of a mobile terminal, the set of instructions directs the processor to perform acts of:
obtaining monitoring data by monitoring occurrence of a first event in a mobile terminal after startup, wherein the first event comprises running at least an application and a process;
determining occurrence of a second event that corresponds to the monitoring data when the monitoring data reaches a preset threshold value;
determining prompt information that corresponds to the second event; and
playing video data associated with the prompt information on the mobile terminal.

16. The storage medium according to claim 15, wherein the set of instructions further directs the processor to perform acts of:
determining that the monitoring data reaches a preset threshold value when the monitoring data correspond to the application and the process have reached the preset threshold value within a preset period of time.

17. The storage medium according to claim 15, wherein the second event comprises at least one of:
an event of low available memory space of the mobile terminal,
an event of system updating of the mobile terminal,
an event of high power consumption by a single process of the mobile terminal,
an event of high memory consumption by a single process of the mobile terminal,
an event of an excessively great difference between screen brightness of the mobile terminal and ambient light of the mobile terminal,
an event of an excessively high ambient temperature detected by the mobile terminal,
an event of an excessively low ambient temperature detected by the mobile terminal,
an event of falling of the mobile terminal,
an event of rapid movement of the mobile terminal,
an event of a small distance between the mobile terminal and a target terminal, and
an event of high load pressure of the mobile terminal.

18. The method according to claim 15, wherein the prompt information is a segment of virtual image motion animation of a virtual image in the mobile terminal.

19. The storage medium according to any one of claim 15, wherein after the playing of the video data associated with the determined prompt information on the mobile terminal, the set of instructions further directs the processor to perform acts of:
closing the prompt information after receiving a close instruction for closing the prompt information from a user.

20. The storage medium according to any one of claim 15, wherein after the playing of the video data associated with the determined prompt information on the mobile terminal, the set of instructions further directs the processor to perform acts of:
closing the prompt information, after duration of the prompt information displaying on the mobile terminal has reached a preset time length.
